(19) United States
(12) Patent Application Publication
(10) Pub. No.: US 2011/0246011 A1
(43) Pub. Date: Oct. 6, 2011

(54) OPERATING METHOD FOR A HYBRID VEHICLE WHICH IS DRIVEN ON A CIRCUIT

(75) Inventors: Joerg Meyer-Ebeling, Stuttgart (DE); Momme Karstens, Stuttgart (DE)

(73) Assignee: DR. ING. H.C.F. PORSCHE AKTIENGESELLSCHAFT, Stuttgart (DE)

(21) Appl. No.: 13/077,146

(22) Filed: Mar. 31, 2011

(30) Foreign Application Priority Data
Apr. 6, 2010 (DE) 10 2009 016 328.7

(51) Int. Cl. B60L 15/20; G06F 19/00

(52) U.S. Cl. 701/22; 180/65.285; 903/903

(57) ABSTRACT

A hybrid vehicle has an internal combustion engine and a coolable electrical system having at least one connectable electrical machine, power electronics and energy store. The electrical machine can be operated as a motor or a generator. The acceleration profiles of the vehicle, power profiles of the electrical system and temperature profiles of the electrical system are recorded and stored during the respective lap that is being driven and, furthermore, the profile of the performance of the electrical system is optimized with respect to the thermal load capacity of the electrical system in the respective next lap. This allows an optimum power profile of the electrical machine during real operation when a circuit is driven around repeatedly.

### CROSS REFERENCE TO RELATED APPLICATION

This application claims priority under 35 USC 119 to German Patent Application No 10 2010 016 328.7 filed on Apr. 6, 2010, the entire disclosure of which is incorporated herein by reference.

### BACKGROUND OF THE INVENTION

1. Field of the Invention

The invention relates to an operating method for a hybrid vehicle that is driven on a circuit. The hybrid vehicle has an internal combustion engine and a coolable electrical system having at least one connectable electrical machine, power electronics and energy store. The electrical machine can be operated as a motor or a generator.

2. Description of the Related Art

The energy store of a hybrid vehicle generally is in the form of a battery. Alternatively, energy stores can store the kinetic energy from the electrical machine in the generator mode as rotation energy, which is emitted again during subsequent motor operation.

The optimum power profile of the electrical system is of critical importance when a hybrid sports vehicle is used on circuits. This optimum power profile depends on driving with an operating strategy that allows optimum use of the electrical machine and of the electrical system at the thermal load limit. This operating strategy should be seen against the background that, depending on the operating state of the electrical system, this system is subject to varying thermal conditions, and it is essential to avoid permanent damage to hybrid components. Thus, the electrical machine cannot be operated without restrictions.

DE 10 2007 045 031 A1 discloses a method for warning of imminent thermal overloading of a vehicle drive train. This vehicle drive train has an internal combustion engine, an electrical machine, at least one clutch and a device for determining a variable that indicates overloading of the internal combustion engine, of the electrical machine or of the clutch. The electrical machine is connected to an output shaft that drives at least one vehicle wheel so that they rotate together. In the presence of a variable that indicates overloading of the internal combustion engine, of the electrical machine or of the clutch, the electric machine is operated to introduce a torque into the drive train.

The object of the present invention is to provide an operating method that allows an optimum power profile of the electrical system during real operation when the circuit is driven around repeatedly.

### SUMMARY OF THE INVENTION

The invention relates to an operating method wherein the acceleration profile of the vehicle, the power profile of the electrical system and the temperature profile of the electrical system are recorded and stored during the respective lap that is being driven. This recording and storage process is carried out once again during each lap that is being driven. As a result, the profiles of the variables determined in the previous lap can be compared with profiles of the variables determined in the next lap, and this comparison is used as a basis in the respective next lap to optimize the profile of the performance of the electrical system with respect to the thermal load capacity of the electrical system.

The operating method of the invention is based on the assumption that the hybrid vehicle has the internal combustion engine and at least one electrical machine. The electrical machine can be operated as a motor to drive the hybrid vehicle in addition to the internal combustion engine. Furthermore, the electrical machine can be operated as a generator to brake the hybrid vehicle (recuperation). The circuit has a sequence of straights and bends that must be driven around in a minimum time (lap time).

The operating method will first of all strongly accelerate the hybrid vehicle in accordance with this sequence by the hybrid vehicle being driven by the internal combustion engine and the one or more electrical machines operated as a motor. This is followed by less acceleration or rolling, during which only the internal combustion engine drives the hybrid vehicle. This is followed by heavy braking, by the one or more electrical machines being operated as a generator. This sequence is then repeated a number of times successively in the course of the lap. However, when minimizing the lap time, attention must be paid to the thermal conditions of the electrical system, including the electrical machine, power electronics and energy store, such as the battery. The components of the electrical system, that is to say the hybrid components, are heated severely during overload operation, namely during boosting or recuperation above the rated power of the electrical machine. The components of the system must be operated at the rated power or at a power less than the rated power to cool the components after overload operation to prevent permanent damage to the electrical system.

The method may include recording at least the acceleration profile of the vehicle, the power profile of the electrical system and the temperature profile of the electrical system throughout each lap on the circuit to minimize the lap time and to allow for the thermal conditions of the components. The basis for determining the acceleration profile of the vehicle is to determine a multiplicity of acceleration values. A corresponding situation applies to determining the power profile and the temperature profile of the electrical system. The operating method uses these recorded data to change the operation of the components of the electrical system during the next lap of the circuit. This therefore results in an optimized operating strategy for driving around a specific circuit with an optimized lap time.

The method may further include recording and storing the time and/or distance traveled during the respective lap that is being driven. The method also may include recording and storing, the profile of the longitudinal acceleration and lateral acceleration of the vehicle during the respective lap that is being driven. Recording the lateral acceleration is important for the optimum speed when driving around a bend section of the circuit.

The components of the electrical system are heated considerably during operation. Thus, the method may account for cooling the electrical system. Accordingly, the method may include recording and storing the temperature profile of a coolant for the electrical system during the respective lap that is being driven. The modification of the driving mode of the hybrid sports vehicle therefore includes not only the determined temperature profile of the electrical system, but also the determined temperature profile of the coolant for the electrical system when driving the next lap.

Driving on a circuit consists, in terms of a diagrammatic representation of the vehicle speed as a function of the driving time, in principle of a sequence of peak-to-peak sections. Starting from a first peak, the vehicle is first of all accelerated, and the vehicle is then braked until the following peak is reached. With regard to this aspect, the method may include recording successive peak-to-peak sections of the speed or acceleration of the vehicle, and optimizing the profile of the performance of the electrical system with respect to the thermal load capacity of the electrical system correspondingly on a section basis, during the respective lap that is being driven.

Performance of the electrical system can be optimized with respect to thermal load capacity of the electrical system in the respective lap from a variety of aspects, with the values and profiles of the electrical system applicable at the respective optimization time influencing the nature and the scope of the optimization with a lasting effect: Therefore, the method preferably includes operating the electrical machine briefly overloaded starting from a cold electrical machine during motor and/or generator operation of the electrical machine. After reaching the maximum permissible operating temperature, the electrical machine is switched off and cooled down, or still operated at most at the rated power during motor and/or generator operation of the electrical machine.

Furthermore, the electrical machine preferably is operated at the rated power at the maximum permissible operating temperature during motor operation of the electrical machine. During motor operation of the electrical machine, the electrical machine can invariably be operated at operating points below and above the rated power.

It is also when possible to operate the electrical machine overloaded during motor operation of the electrical machine, when the temperature of the electrical system is below its maximum permissible operating temperature.

The method may include optimizing the magnitude of the overload power and/or overload duration of the electrical machine on the basis of a temperature profile over time.

The power profile of an energy store in the form of a battery and the temperature profile of the battery preferably are recorded and stored during the respective lap that is being driven, and the optimized operating strategy for driving this specific circuit is implemented taking account of this data.

The above optimization criteria that relate in particular to electrical machines, apply correspondingly to the energy store, in particular the battery and the power electronics, such as a pulse-controlled inverter that is used here.

The operating method of the invention therefore makes it possible, in the case of a motor vehicle used on a circuit, such as a hybrid sports vehicle, to drive with an operating strategy that represents the optimum between the thermal load capacity of the electrical system and the lap-time-optimum power profile. Operating strategies can be used for regulating the maximum power output on the basis of instantaneous measurement results and characteristics of the electrical system. Furthermore, the method may include presetting additional maximum generator or motor power limits, thus resulting in a roughly thermally compatible power profile around a circuit.

The operating method of the invention includes using a system with the capability to learn from laps that have been driven. The method may include making recordings as to when and where in the section what power level is recuperated or used for driving. This method step can be done, for example, by section measurement, time measurement or GPS. The method then includes using this information so that the electrical system can decide at any time, on a lap-time-optimum basis, at the time of the decision and at subsequent times, when to use energy contained in the energy store as traction power, and when to charge the energy store by recuperation. Such an optimized and adaptive operating strategy can lead to improved lap times by optimum use of the electrical system.

Further features of the invention are specified in the dependent claims, the attached drawing and the description of one preferred exemplary embodiment of the operating method, with reference to the drawing, although without being restricted to this.

### BRIEF DESCRIPTION OF THE DRAWINGS

FIG. 1 shows an example of a track section for driving on a circuit, in order to illustrate the peak-to-peak sections in the v-t diagram, with different sections such as these following one another around the entire circuit.

FIG. 2 jointly shows the v-t diagram and an associated p-t diagram, as well as a further diagram relating thereto, which illustrates the relationship between the power of the electrical machine and the time t_{E} for which it is switched on.

FIG. 3 jointly shows an illustration of the diagram of the power as a function of the time t_{E} for which the electrical machine is switched on, and the temperature profile as a function of the time for which the electrical machine is switched on.

FIG. 4 shows a flowchart in order to illustrate the operating method according to the invention.

### DETAILED DESCRIPTION OF THE PREFERRED EMBODIMENT

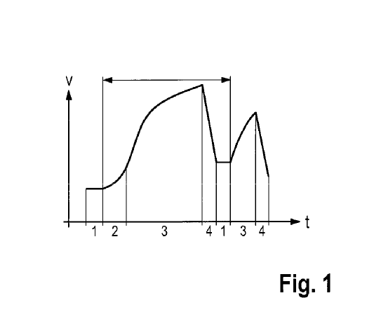

An assessment of a speed-time diagram (v-t diagram) when driving around a circuit, such as a racetrack, in a hybrid vehicle, in particular a hybrid sports vehicle, results in a sequence of peak-to-peak sections. In precisely the same way, a diagrammatic illustration of the state of charge of the energy store, in particular the state of charge of the battery, results in a sequence of peak-to-peak sections as a function of the driving time on the respective lap. FIG. 1 illustrates a peak-to-peak section such as this for a v-t diagram. The peak-to-peak section starts with a first peak 1, shown on the left, which is followed by an acceleration section 2 below the slip limit and, after this, an acceleration section 3 above the slip limit. The acceleration section 3 is followed by a braking section 4, which is followed by a next peak 1. Because of the configuration of the circuit, the peak 1 to the peak 1 is followed by a peak-to-peak section with a different configuration, as is subsequently illustrated in FIG. 1. The most recently mentioned peak 1 which follows the braking section 4 is followed immediately by an acceleration section 3 above the slip limit, which is followed by a braking section 4, which would then be followed by a new peak.

FIG. 1 shows a peak-to-peak section by means of the double-headed arrow arranged above the curve. The successive peak-to-peak sections illustrate the process of driving one lap of the circuit. The sequence of the peak-to-peak sections is changed because of the driving on the circuit as optimized according to the invention.

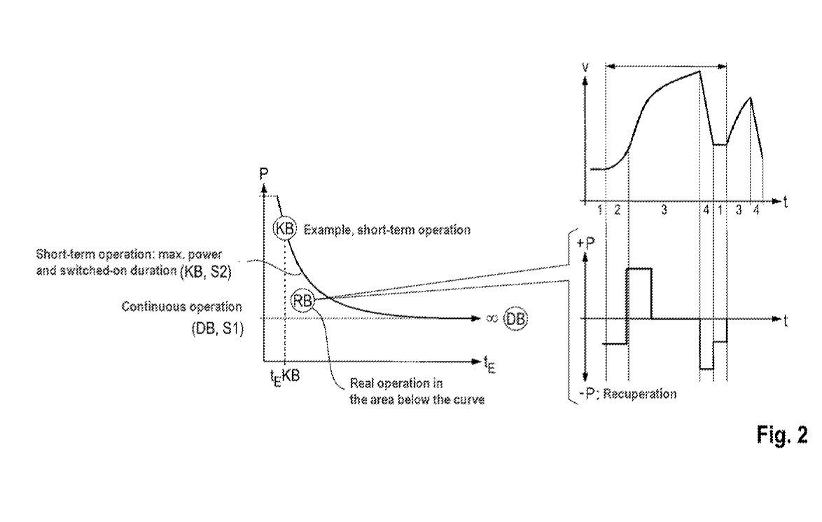

At the top on the right, FIG. 2 shows an example of the track section shown in the v-t diagram illustrated in FIG. 1, and, under this diagram, likewise related to the time t, therefore the time of the vehicle as it drives off the circuit, the illustration of the power P of the electrical machine as a function of the time t. On the basis of the illustrated acceleration and braking processes, the motor operation of the electrical machine (+P) and the generator operation of the electrical machine (−P), this correspondingly clearly shows the recuperation and the shift in the load point in the last-mentioned case.

The left-hand diagram shows in FIG. 2, from the aspect of the power diagram on the right-hand side, the dependence of the power P of the electrical machine on, in this case, the time t_{E} for which the electrical machine is switched on.

FIG. 2 illustrates that the operation of the electrical system on the circuit comprises a successive change from drive (P>0), recovery (P=0) and recuperation (P<0) which heats the components of the electrical system, by losses. In this case the components of the electrical system can be overloaded briefly above the continuous power (also referred to as the rated power).

During operation on the circuit, the electrical system essentially is operated with alternation between the successive peak-to-peak sections, as illustrated in the upper right-hand diagram in FIG. 2. This results in a time profile of the electrical power P as the change from drive (P>0), recovery (P=0) and recuperation (P<0). All of the components in the electrical system are heated by losses (for example, mechanical, resistive, in the magnetic circuit). A cooling system extracts this heat from the components.

As can be seen from the left illustration in FIG. 2, more power can briefly be requested in the electrical system (also referred to as overload operation) than for continuous loading to which the components are stabilized to equilibrium thermally in the limits of the maximum thermal load. In terms of power, the real operation takes place in a range below the curve of the maximum powers with different short-term loads.

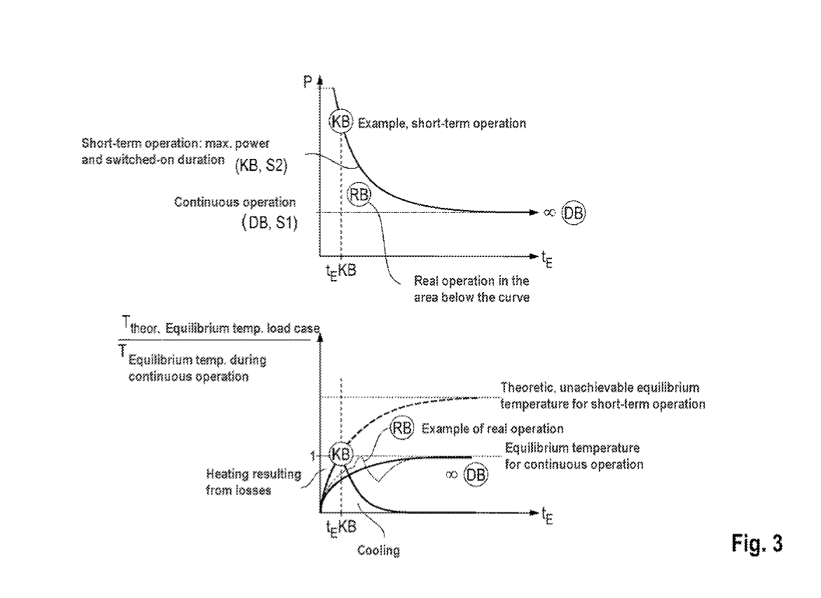

In one P-t_{E} diagram which corresponds to the left-hand diagram shown in FIG. 2, corresponding to this, FIG. 3 shows the temperature profile in the electrical machine as a function of the time t_{E} for which it is switched on. There are corresponding time profiles of the temperatures for the other components in the electrical system as well for the individual points in the power/time diagram, that is to say not only the illustrated relationships for the electrical machine, but also those for the battery and a pulse-controlled inverter.

FIG. 3 shows that the short-term operation KB—overload operation—can be used, starting from a cold motor generator, only for a switched-on time t_{E}KB which is governed by the design, since the theoretically achievable equilibrium temperature would otherwise thermally damage the electrical machine.

Once the maximum permissible operating temperature has been reached after the time t_{E}KB, the electrical machine is either cooled down after being switched off (see KB in the diagram), or can still be operated at most at the rated power.

During operation at the continuous or rated power DB, the equilibrium temperature corresponds to the maximum permissible operating temperature of the electrical machine. The electrical machine can therefore be operated indefinitely.

Real operation RB comprises operating points below and above the rated power.

Overload operation is possible only provided that the temperature is below the maximum permissible operating temperature, which is to say only after a certain cooling-down time or operating time below the rated power. The level of the overload power or the overload duration depends on the instantaneous temperature of the motor.

The operating method of the invention makes it possible to optimize the power profile during real operation over the laps such that the electrical system is operated on a lap-time-optimum basis in conjunction with the described thermal constraints.

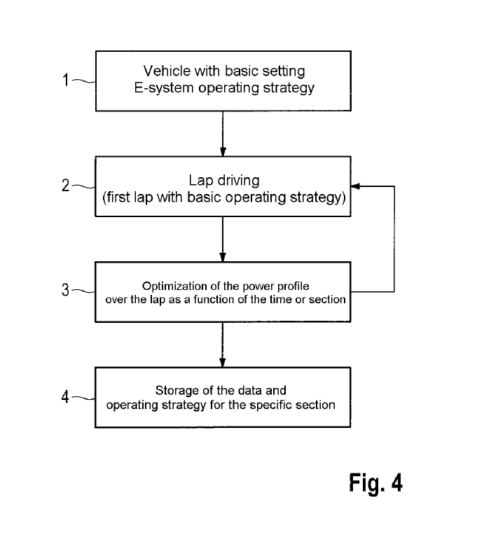

FIG. 4 shows a flowchart in order to illustrate the operating method according to the invention.

A vehicle is assumed which is in a basic setting in terms of the operating strategy of the electrical system. By way of example, the vehicle is intended to be driven on the circuit with maximum recuperation and power demand up to the thermal limit, from the electrical system.

The first lap is driven using this basic operating strategy. Data is recorded and is stored relating to the time, section, longitudinal and lateral acceleration, power, energy profile, temperature of electrical components, coolant temperature.

The power profile over the lap is then optimized as a function of the time or section. The performance of the electrical system is maximally utilized in conjunction with the thermal load capacity, in order to reduce the lap time. This results in an optimum profile of the power of the electrical system along the section.

As is illustrated by the arrow at the side in FIG. 4, continuous optimization takes place from one lap to another between the states 1 and 2. Once this optimization has been completed, the final storage of the data and operating strategy for the specific circuit are produced as the fourth step.

What is claimed is:

1. An operating method for a hybrid vehicle that is driven on a circuit, the hybrid vehicle having an internal combustion engine and a coolable electrical system with at least one connectable electrical machine, power electronics and at least one energy store, the electrical machine being operable as a motor or as a generator, the circuit having a sequence of straights and bends, the method comprising:
recording and storing an acceleration profile of the vehicle, a power profile of the electrical system and a temperature profile of the electrical system during each respective lap that is driven, and
optimizing the profile of performance of the electrical system with respect to a thermal load capacity of the electrical system in a next lap.

2. The method of claim 1, further comprising recording and storing at least one of a time and a distance traveled during each respective lap that is being driven.

3. The method of claim 2, further comprising recording and storing a profile of at least one of longitudinal acceleration and lateral acceleration of the vehicle during each respective lap that is being driven.

4. The method of claim 3, further comprising recording and storing a temperature profile of a coolant for the electrical system during each respective lap that is being driven.

5. The method of claim 1, further comprising recording successive peak-to-peak sections of speed or acceleration of the vehicle, and optimizing the profile of the performance of the electrical system with respect to the thermal load capacity of the electrical system on a section basis during the respective lap that is being driven.

6. The method of claim 1, further comprising operating the electrical machine overloaded for a limited time starting from a cold electrical machine during motor or generator operation of the electrical machine.

7. The method of claim 6, further comprising switching off the electrical machine after reaching a maximum permissible operating temperature or operating the electrical machine at most at a rated power during motor or generator operation after reaching a maximum permissible operating temperature of the electrical machine to allow cooling down.

8. The method of claim 1, further comprising operating the electrical machine at a rated power at a maximum permissible operating temperature during motor or generator operation of the electrical machine.

9. The method of claim 1, further comprising operating the electrical machine at operating points below and above a rated power during motor or generator operation of the electrical machine.

10. The method of claim 1, further comprising operating the electrical machine overloaded during motor or generator operation of the electrical machine when the temperature of the electrical system is below a maximum permissible operating temperature.

11. The method of claim 1, further comprising optimizing a magnitude of overload power or overload duration of the electrical machine on the basis of the temperature profile over time.

12. The method of claim 1, further comprising recording and storing a power profile of a battery and a temperature profile of the battery during the respective lap that is being driven.
